(19) United States
(12) Patent Application Publication
(10) Pub. No.: US 2024/0308310 A1
(43) Pub. Date: Sep. 19, 2024

(54) Embedded car cover

(71) Applicant: ZHEJIANG SURPASS AUTO PARTS CO.,LTD., Wenzhou City (CN)

(72) Inventors: Yunyan He, Wenzhou City (CN); Wuyi Chen, Wenzhou City (CN); Yi Lin, Wenzhou City (CN); Lei Lin, Wenzhou City (CN)

(21) Appl. No.: 18/193,998

(22) Filed: Mar. 31, 2023

(30) Foreign Application Priority Data
Mar. 16, 2023 (CN) 202310277084.2

(51) Int. Cl. B60J 7/14; B60J 7/19; B60P 7/02; B62D 33/02

(52) U.S. Cl. CPC B60J 7/141; B60J 7/198; B60P 7/02; B62D 33/02

(57) ABSTRACT

The present invention discloses a hard flipping car cover including a front bar system, a first plate body, a second plate body, a third plate body and a supporting system, the supporting system includes a buffer plate, a buffer block and a large front bar rotating shaft, the buffer plate is connected to the front car cab, the buffer block is connected to the front bar system, the first plate body is rotatably connected to the front bar system by a large front bar rotating shaft, the first plate body is rotatably connected to the second plate body by a first rotating shaft system, the second plate body is connected to the third plate body by a second rotating shaft system. The invention achieves a three-point positioning of the first plate body by the large front bar rotating shaft, the buffer plate and the buffer block. When the first plate body is flipped up, the upper end of the first plate body comes against the buffer plate while the first rotating shaft system presses against the buffer block, at which time the angle between the plate body and the horizontal surface is greater than 90°, enabling the plate body to stand.

### TECHNICAL FIELD

This invention is relevant to automobile accessories, especially a hard flipping car cover.

### BACKGROUND TECHNOLOGY

The cargo hopper of a pick-up truck (also known as a sedan truck) is used to carry goods, as long as it is open, in order to avoid the rain from wetting the goods inside the cargo hopper in rainy and snowy weather, a car cover is invented and installed on the cargo hopper of the pick-up truck, using the car cover to shelter the goods in the cargo hopper to avoid the goods inside from being wet by rain.

The existing car cover is erected at 90° and the supporting system is concentrated at the point of support, which makes the supporting system prone to damage.

Moreover, most existing covers require multiple rotating shaft, the car cover does not need to be fully opened in practice, the frequently used rotating shaft system is prone to damage if a lower cost rotating shaft system is used, while the usage of a higher cost rotating shaft result in a higher production cost of the entire car cover.

### About the Invention

The purpose of the invention is to provide a car cover with multiple rotating shaft, make better stability of the supporting system as well as longer service life by improving the supporting system, secondly, the cost and service life of the different rotating shaft systems are used to make the car cover more economical.

In order to solve the above problems of the existing technology, the technical solution adopted in the invention is as follows.

A hard flipping car cover, includes a front bar system, a first plate body, a second plate body, a third plate body and a supporting system.

The supporting system includes a buffer plate, a buffer block and a large front bar rotating shaft, the buffer plate is connected to the front car cab, the buffer block is connected to the front bar system,

The first plate body is rotatably connected to the front bar system by the large front bar rotating shaft, the first plate body is rotatably connected to a second plate body by a first rotating shaft system.

The second plate body is rotatably connected to the third plate body by a second rotating shaft system

The three-point positioning of the first plate body is achieved by means of a large front bar rotating shaft, a buffer plate and a buffer block. When the first plate body is turned up, the upper end of the first plate body rests on the buffer plate, while the first rotating shaft system presses on the cushion plate, at which point the angle between the plate body and the horizontal plane is greater than 90°, enabling the plate body to stand.

Further, the supporting system includes a supporting pole assembly and a large front bar rotating shaft, the supporting pole assembly includes a supporting pole, a supporting pole head and a supporting block, the supporting pole head is connected to the plate body through a supporting base, the supporting base is set parallel to the plate body, the supporting block includes a fixing section, an inclined plate, a supporting groove and a transition section, the fixing section is connected to the cargo hopper, the inclined plate is connected to the fixing section through the transition section, the inclined plate is inclined 15-25° with respect to the fixing section, the inclined plate is provided with a “U” shaped supporting groove, the supporting pole is snap fitted into the supporting groove, the large front bar rotating shaft includes a top pillar and a front bar rotating centre, the front bar rotating centre is connected to the top pillar by rotation, the front bar rotating centre is connected to the first plate body by a connecting arm, the front bar rotating centre is provided with a first limiting section, the top pillar is rounded, the top pillar is provided with a second limiting section which is adapted to the first limiting section, the large front bar rotating shaft not only drives the first plate body to turn over, but also supports the first plate body after rotation by using its hard connection structure. By adjusting the position of the connecting arm, it is possible to control the rotation angle of the large front bar rotating shaft and thus the angle of rotation of the first plate body. As the plate body is able to turn 95°-110° when rotating, the plate body is not completely vertical when standing up but forms an obtuse angle of 95°-110° with the cargo hopper, so that the supporting base can be directly connected to the plate body and set parallel to it, whereas the existing plate body can only turn 90°, so that the supporting base needs to make an oblique angle of about 15° when it is connected to the plate body in order to facilitate the connection of the supporting pole, as the supporting pole is tilted to support the plate body after it is standing up, tilting the inclined plate by 15-25°, the supporting pole has a larger contact area between the nut and the inclined plate after it is connected to the inclined plate, the inclined plate is subjected to a more even force, which not only supports more stability but also extends the service life of the supporting block. the buffer plate can be in the form of a long strip or a plurality of blocks structures lined up in sequence in the structure. As long as it is possible to support the plate body up.

Further, the buffer block includes a buffer pad and a fixing pad, the fixing pad is connected to the front bar system, the buffer pad is connected to the fixing pad, the buffer pad is of an “L” shape, the buffer pad is used to support the plate body, the “L” shape of the buffer pad prevents the second rotating shaft system from sliding. The buffer block can be a single fixing pad or a buffer pad which is connected to the fixing pad. the car cover is shipped with only the fixing pad, the customer can choose according to the actual demand.

Further, the first rotating shaft system includes a first intermediate rotating bar and two first side bars, the two first side bars are respectively connected to the first intermediate rotating bar by rotation, the first side rods are provided with a side bar mounting groove, the side bar mounting grooves are C-shaped, the first intermediate rotating bar is provided with an intermediate mounting groove at each end, the intermediate mounting grooves are C-shaped, the two first side bars are connected to the first intermediate rod by a first connecting strip, the first connecting strip is made of rubber, the first connecting strip includes a first connecting surface and two first feet, the two first feet are connected by the first connecting surface, the two first feet are located in the side bar mounting groove and the intermediate mounting groove respectively. The first side bar is provided with a side bar convex block, the side bar convex block is connected to the notch of the side bar mounting groove, the first intermediate rotating bar is provided with an intermediate convex block, the intermediate convex block is connected to the notch of the intermediate mounting groove, the intermediate convex block is longer than the side bar convex block or shorter, as long as the notches of the side bar mounting groove and the intermediate mounting groove are not the same size. By providing side bar convex block in the side bar mounting groove and intermediate convex block in the intermediate mounting groove and controlling the length of the side bar convex block and intermediate convex block, the size of the groove notch can be reduced so that the first foot in the side bar mounting groove can be removed after it is extended into the side bar mounting groove and the intermediate mounting groove due to the shorter side bar convex block, the first foot in the intermediate mounting groove cannot be removed if the intermediate convex block is longer. As the first bottom foot can be removed from the side bar mounting groove, the first connecting strip plays only a waterproof role but not the connecting role. The connection of the first rotating shaft system is achieved by the first intermediate rotating bar and the front bar rotating centre of the first side bar, the first rotating shaft system uses a rubber strip to reasonably reduce production costs

Further, the first rotating shaft system has a left end cap, a right end cap and an intermediate end cap connected at each end, the left end cap and right end cap are screwed to the two first side bars respectively, the intermediate end cap is screwed to the first intermediate rotating bar, the left end cap is provided with a left end cap top panel, the right end cap is provided with a right end cap top panel and the intermediate end cap is provided with an intermediate end cap top panel, the left end cap top panel, the right end cap top panel and the intermediate end cap top panel are all provided on the upper side of the first connecting surface. The first connecting strip is of “π” shape, the first foot is connected to the first connecting surface by means of a connector, the size of the first foot is larger than the size of the connection member, the connector is slightly smaller than the notch of the intermediate mounting groove, the First connecting strip is designed as a “π” structure, which is not only stable but also good for waterproofing, furthermore, the first connecting strip is set on the upper side of the rotation centre of the front bar of the first rotating shaft system, so that when the first rotating shaft system is rotating, the first connecting strip will not be subject to tension, which prevents damage to the first connecting strip caused by long-term rotation.

Further, the rotating shaft system includes a second rotating shaft system, the second rotating shaft system includes a second intermediate rotating bar and two second side bars, the two second side bars are connected to the second intermediate rotating bar by rotation, the second side bars are provided with a side bar mounting groove, the second intermediate rotating bar is provided with two intermediate mounting grooves, the second side bars are connected to the second intermediate rotating bar with a second connecting strip, the second connecting strip includes a second connecting surface and two mounting sections, the second connecting surface can be leather or other non-elastic flexible material, the two mounting sections are connected by the second connecting surface, each mounting section is connected with a second foot, the two second feet are located in the side bar mounting groove and the intermediate mounting groove respectively, the second rotating shaft system designed the second connection bar as a split structure, the second connecting surface and the mounting section are connected by glue during installation, the second foot is similarly inserted into the profile when using. The second connecting surface has a longer service life due to its plastic material. Since the second rotating shaft system has to be opened each time it is opened, adopting a plastic material for the second rotating shaft system not only extends the service life of the second rotating shaft system but also reduces the cost.

Further, the mounting section includes a pressing plate, a connecting section and a supporting section, the supporting section is provided with a connecting section on its upper side, the connecting section is provided with a pressing plate on its upper side, the pressing plate is provided with an insertion port between the pressing plate and the supporting section, the second connecting surface is provided with insertion ends at both ends, the insertion ends extend into the insertion port, the two insertion ports are provided opposite each other.

Further, the car cover further includes a guide rail, a clamp system and a lock system, the guide rail is connected to the cargo hopper through the clamp system, the lock system includes a cylindrical lock bolt head and a lock bolt, the lock bolt is connected to the car cover, the cylindrical lock bolt head is connected to the cargo hopper or the guide rail by a clamp system, each cover plate is provided with a lock system correspondingly, each the lock system includes two lock bolts and two cylindrical lock bolt heads, the two cylinders lock bolt are connected on each side of the cargo hopper, the two lock bolts are connected on each side of the plate and correspond to the lock bolt cylinders, the two the lock bolts are connected to each other by means of a wire rope, the wire rope is connected to a handle. By pulling the handle, the locking system can be opened quickly to facilitate the opening of the car cover, in addition, when closing the car cover, just press down on the plate body.

The beneficial effects of the invention are as follows.

The present invention adopts a new supporting system, which uses a three-point positioning to support the car cover when it is been erected, ensuring the stability of the car cover while extending the service life of the supporting system.

By using two different rotating shaft systems, the invention allows the frequently used rotating shaft system of the car cover to have a longer service life whilst lower the cost of the infrequently use rotating shaft system, making the economics of the car cover more apparent.

### DESCRIPTION OF DRAWINGS

FIG. 1 is the connection schematic diagram 1 of the car cover of the invention.

FIG. 2 is the connection schematic diagram 2 of the car cover of the invention.

FIG. 3 is the partial enlarged view of part A in FIG. 2.

FIG. 4 is the schematic diagram 1 of the invention.

FIG. 5 is the sectional drawing 2 of the invention.

FIG. 6 is the partial enlarged view of part B in FIG. 5.

FIG. 7 is the structure schematic diagram of the rotating shaft system.

FIG. 8 is the partial enlarged view of part C in FIG. 7.

FIG. 9 is the inner structure schematic diagram of the rotating shaft system.

FIG. 10 is the partial enlarged view of part D in FIG. 9.

FIG. 11 is the structure schematic diagram of the second rotating shaft system.

FIG. 12 is the partial enlarged view of part E in FIG. 11.

FIG. 13 is the explosion diagram of FIG. 1.

FIG. 14 is the partial enlarged view of part F in FIG. 13.

FIG. 15 is the partial enlarged view of part H in FIG. 1.

FIG. 16 is the schematic view 1 of the opening of the car cover

FIG. 17 is a partial enlargement of part G of FIG. 16.

FIG. 18 is a schematic view 2 of the car cover open.

FIG. 19 is a sectional view of part of the car cover in FIG. 18.

FIG. 20 is a partially enlarged view of part J in FIG. 19

FIG. 21 is a schematic view of the structure of the supporting block in FIG. 19.

In the figures: 1—Large front bar rotating shaft, 11—Top pillar, 12—Front bar rotating centre, 13—Connecting arm, 14—First limiting section, 15—Second limiting section, 2—First rotating shaft system, 21—First intermediate rotating bar, 2101—Intermediate mounting groove, 2102—Intermediate convex block, 23—First side bar, 2301—Side bar convex block, 2302—Side bar mounting groove, 24—First connecting strip, 2401—First foot, 2403—First connecting surface, 25—Second connecting strip, 251—Mounting section, 2511—Pressing plate, 2512—Connecting section, 2513—Second foot, 2514—Supporting section, 2515—Insertion port, 252—Second connecting surface, 2521—Insertion end, 26—Left end cap, 2601—Left end cap top panel, 27—Right end cap, 2701—Right end cap top panel, 28—Intermediate end cap, 2801—Intermediate end cap top panel, 3—Second rotating shaft system, 31—Second side bar, 41—Cylindrical lock bolt head, 42—Lock bolt, 5—First plate body, 6—Second plate body, 7—Third plate body, 81—supporting pole, 82—supporting pole head, 83—Supporting block, 831—Fixing section, 832—Inclined plate, 833—Supporting groove, 834—Transition section, 84—Buffer block, 841—Buffer pad, 842—Fixing pad, 843—Socket, 85—Buffer plate, 86—Supporting base, 9—Car cab.

### The Concrete Method to Carry Out

The following instruction further explains the invention's concrete implementation method.

In order to enable a clearer understanding of the objects mentioned above, features and advantages of the present invention, the invention is described in detail below in connection with the accompanying drawings and specific embodiments. It should be noted that the embodiments of the present invention and the features in the embodiments can be combined without conflict.

The terms “first”, “second”, “third”, etc. are only used to differentiate the description and should not be construed as indicating or implying relative importance.

In the description of the invention, it should also be noted that, unless otherwise expressly specified and limited, the terms “arranged,” “installed,” “connected,” and “combined” should be understood in a broad sense. for example, it may be a fixing connection, it can also be a detachable connection or an integral connection. it can be a mechanical connection or an electrical connection. it can be a direct connection or an indirect connection through an intermediate media, and it can be internal connection within two assemblies. For those of ordinary skill in this field, specific meanings of the above terms in the present invention can be understood in specific situations.

The specific embodiments of the present invention will be described in detail below in connection with the accompanying drawings. It should be understood that the specific embodiments described herein are intended only to illustrate and explain the present invention and not to limit it.

### Embodiment 1

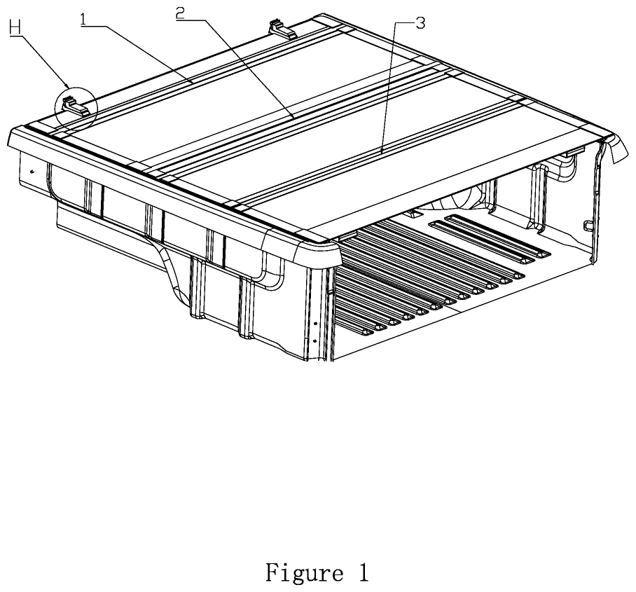

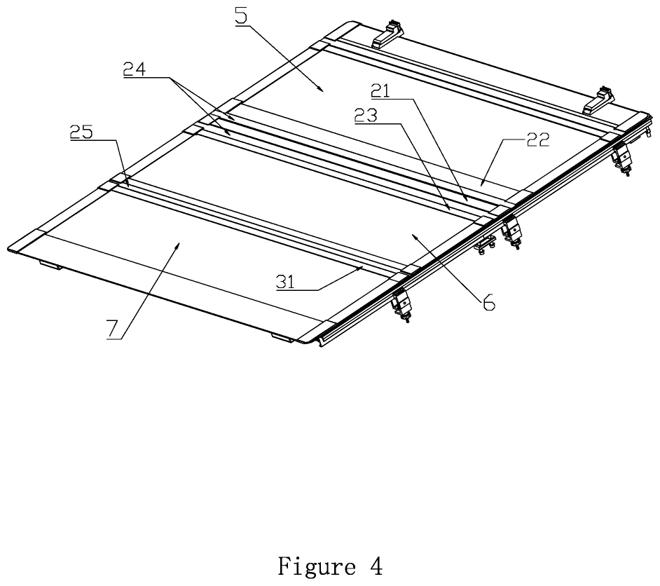

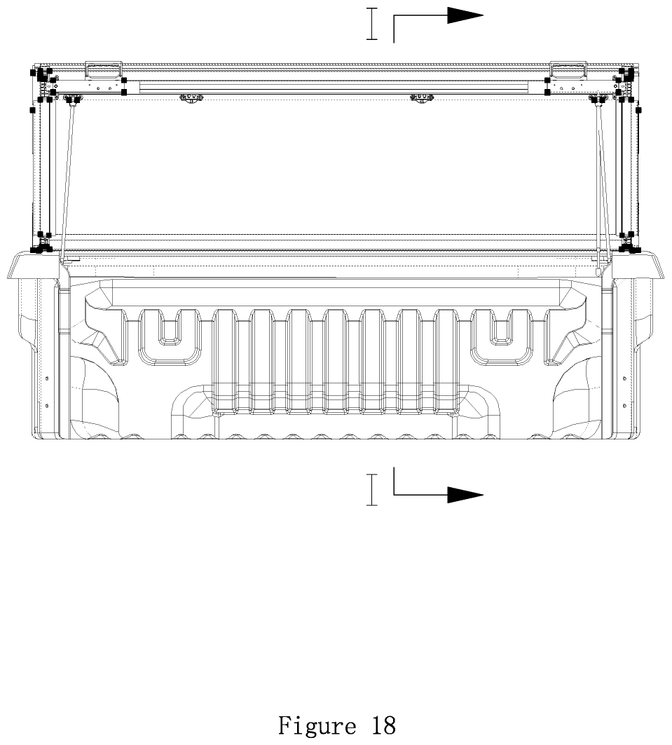

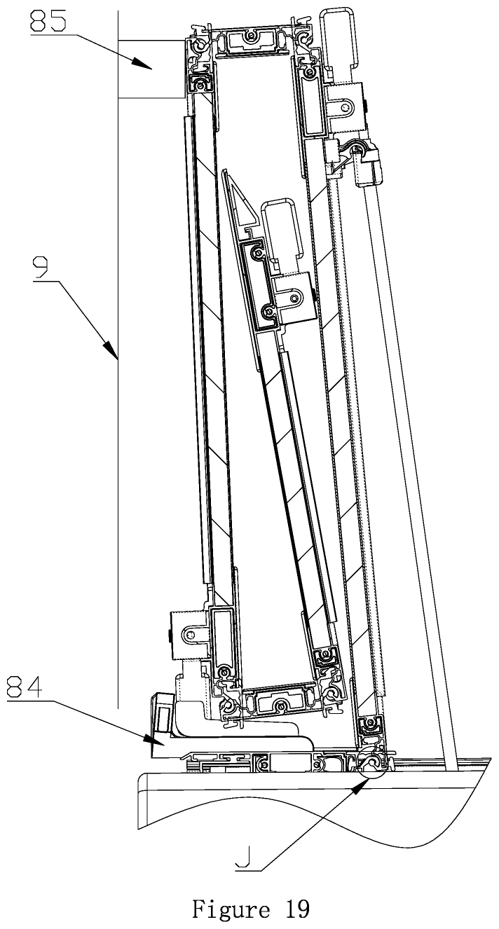

As shown in FIGS. 1, 4, 18 and 19, a hard flipping car cover, includes a front bar system, a first plate body 5, a second plate body 6, a third plate body 7 and a supporting system.

The supporting system includes a buffer plate 85, a buffer block 84 and a large front bar rotating shaft 1, the buffer plate 85 is connected to the front car cab 9, the buffer block 84 is connected to the front bar system,

The first plate body 5 is connected to the front bar system by the large front bar rotating shaft 1 by rotation, the first plate body 5 is connected to a second plate body 6 by a first rotating shaft system 2 by rotation.

The second plate body 2 is rotatably connected to the third plate body 7 by a second rotating shaft system 3.

The three-point positioning of the first plate body 5 is achieved by means of a large front bar rotating shaft 1, a buffer block 84 and a buffer plate 85. When the first plate body 5 is turned up, the upper end of the first plate body 5 rests on the buffer plate 85, while the first rotating shaft system 2 presses on the buffer block 84, at which point the angle between the plate body and the horizontal plane is greater than 90°, enabling the plate body to stand.

### Embodiment 2

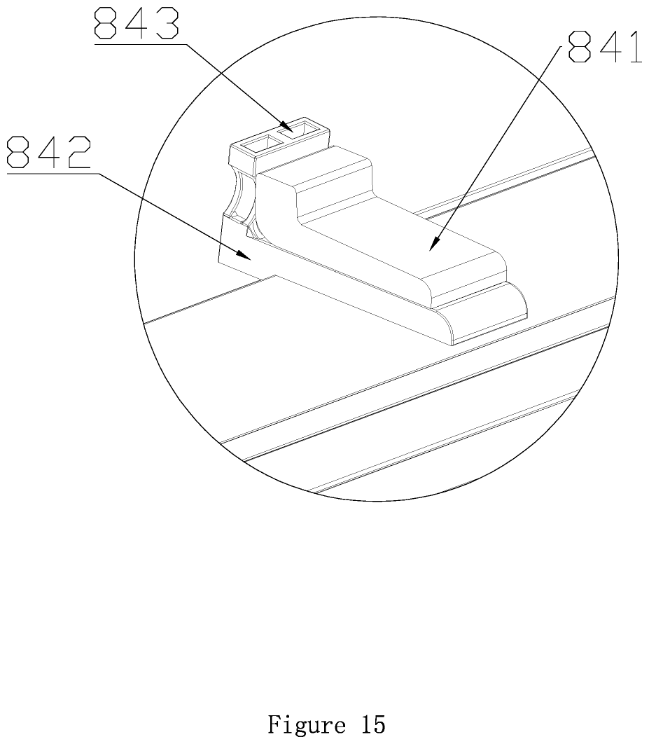

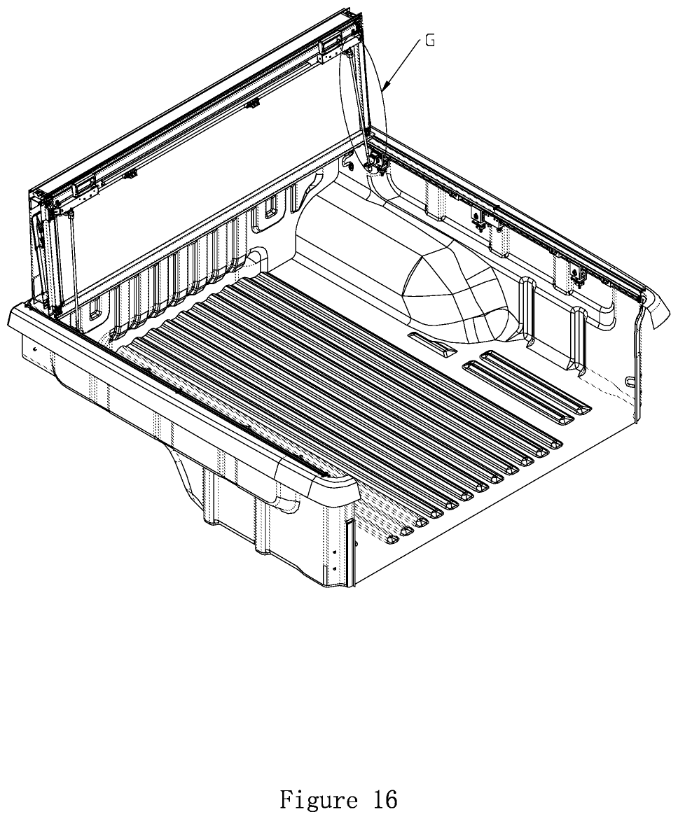

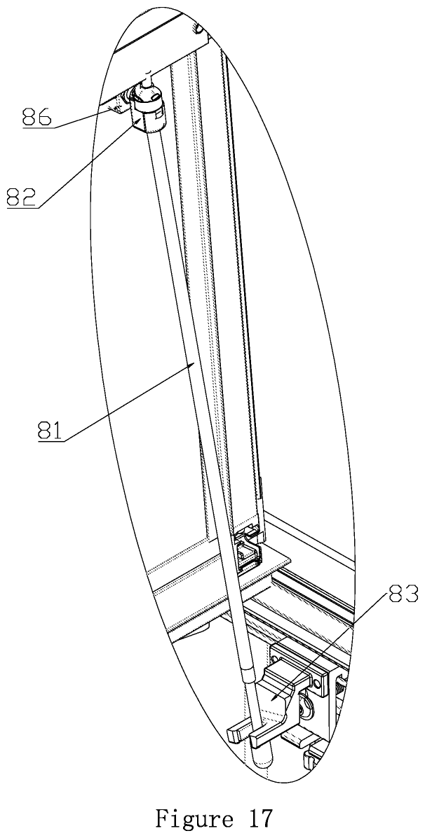

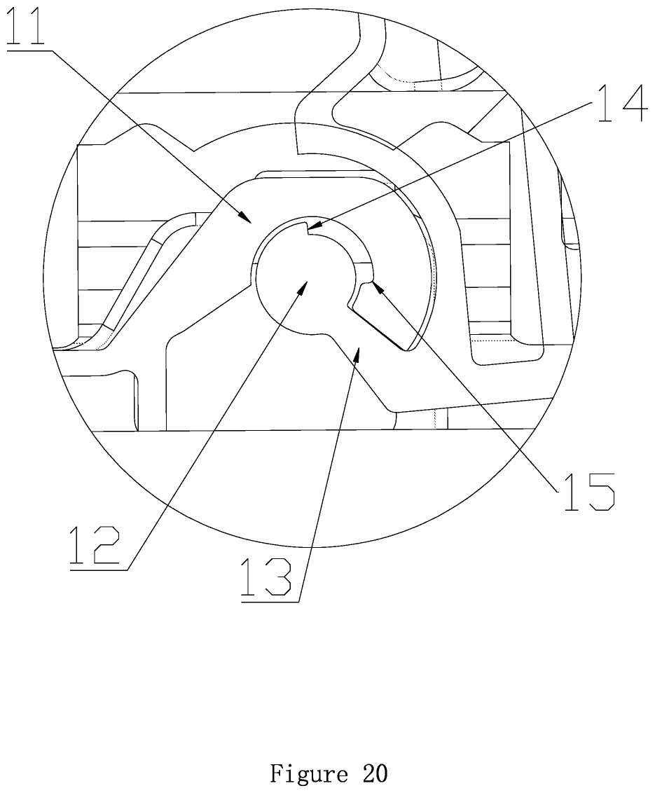

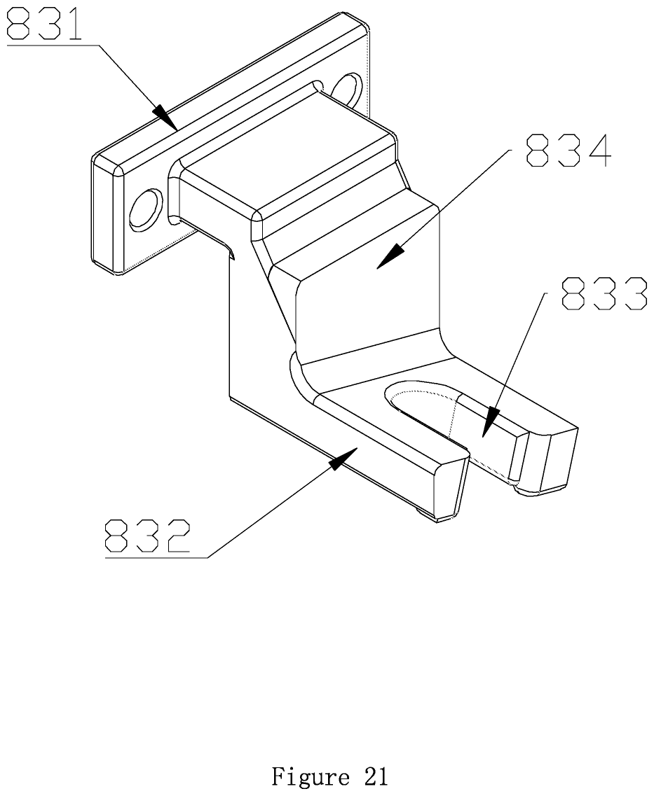

On the basis of embodiment 1, as shown in FIGS. 15-17, 20 and 21, the supporting system includes a supporting pole assembly and a large front bar rotating shaft 1.

The supporting pole assembly includes a supporting pole 81, a supporting pole head 82 and a supporting block 83.

The supporting pole head is connected to the plate body through a supporting base 86, the supporting base 86 is set parallel to the plate body, the supporting block 83 includes a fixing section 831, an inclined plate 832, a supporting groove 833 and a transition section 834, the fixing section 831 is connected to the cargo hopper, the inclined plate 832 is connected to the fixing section 831 through the transition section 834, the inclined plate 832 is inclined 15-25° with respect to the fixed section 831, the inclined plate 832 is provided with a “U” shaped supporting groove 833, the supporting pole 81 is snap fitted into the supporting groove 833.

The large front bar rotating shaft 1 includes a top pillar 11 and a front bar rotating centre 12, the front bar rotating centre 12 is connected to the top pillar 11 by rotation, the front bar rotating centre 12 is connected to the first plate body 5 by a connecting arm 13, the front bar rotating centre is provided with a first limiting section 14, the top pillar 11 is in a circular arc, the top pillar 11 is provided with a second limiting section 15 which is adapted to the first limiting section 14.

The large front bar rotating shaft 1 not only drives the first plate body 5 to turn over, but also supports the first plate body 5 after rotation by using its hard connection structure.

When the car cover is closed, the first plate body 5 is in a horizontal state, at the same time the second limiting section 15 tightens the first limiting section 14 and limits the first limiting section 14, when the car cover is opened, the first plate body 5 is standing up, while the connection arm 13 is against the end of the top pillar 11, which supports the front bar rotating centre 12.

By adjusting the position of the connecting arm 13, it is possible to control the rotation angle of the large front bar rotating shaft 1 and thus the angle of rotation of the first plate body.

As the plate body is able to turn 95°-110° when rotating, the plate body is not completely vertical when standing up but forms an obtuse angle of 95°-110° with the cargo hopper, so that the supporting base 86 can be directly connected to the plate body and set parallel to it, whereas the existing plate body can only turn 90°, the supporting base 86 needs to make an oblique angle of about 15° while connecting to the plate body to facilitate the connection of the supporting pole 81.

In practice, it is necessary to connect a nut (not shown in the drawing) to the supporting pole 81 and use the nut to press against the tilt plate 832 to provide support.

As the supporting pole 81 is tilted to support the plate body after it is standing up, tilting the inclined plate 832 by 15-25°, the supporting pole 81 has a larger contact area between the nut and the inclined plate 832 after it is connected to the inclined plate 832, the inclined plate 832 is subjected to a more even force, which not only supports more stability but also extends the service life of the supporting block 83.

The buffer plate 85 can be either in the form of long strips or a plurality of block structures lined up in sequence as long as it is possible to support the plate body up.

When the plate body is turned over and folded, the third plate body 7 is placed between the first plate body 5 and the second plate body 6, one second side bars 31 of the second rotating shaft system 3 is placed on the buffer pad 841 while the first plate body 5 is pressed against the buffer plate 85, the supporting pole 81 is connected to the supporting block 83, which makes the plate body more stable when it is stood up and prevents the plate body from shaking by the supporting pole 81. After the plate body is stood up, one second side bars 31 of the second rotating shaft system 3 is pressed against the buffer block 84, the other second side bar 31 of the second rotating shaft system 3 together with the second intermediate connection bar 33 are suspended.

The buffer block 84 includes a buffer pad 841 and a fixing pad 842, the fixing pad 842 is connected to the front bar system, the fixing pad 842 is provided with a socket 843, the buffer pad 841 is connected to the fixing pad 842, the buffer pad 841 is of an “L” shape, the buffer pad 841 is used to support the plate body, the “L” shape of the buffer pad 841 is made to hold the second rotating shaft system 3 in place and prevent it from sliding.

The buffer block 84 can be a single fixing pad 842, or the buffer pad 841 which is connected to the fixing pad 842, the car cover is shipped with only the fixing pad 842, customer can choose according to the actual demand.

### Embodiment 3

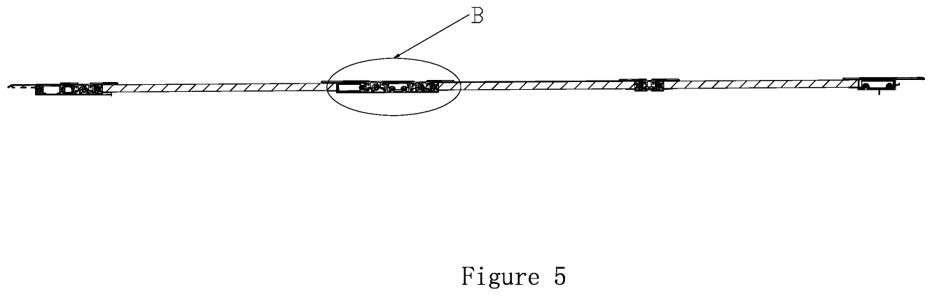

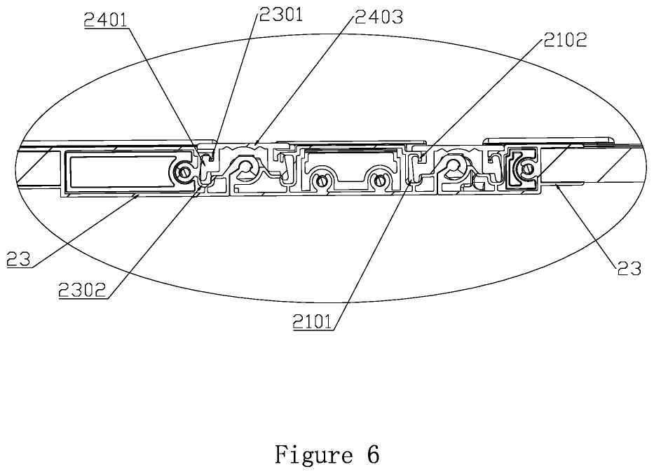

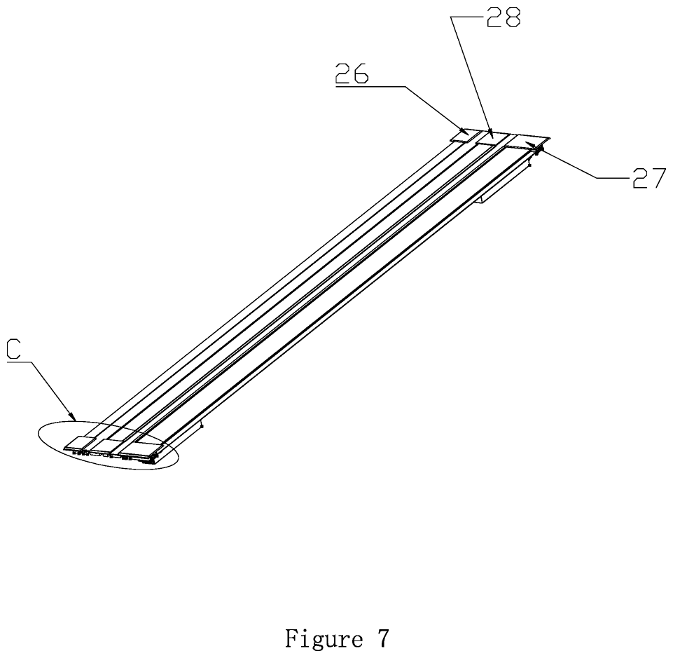

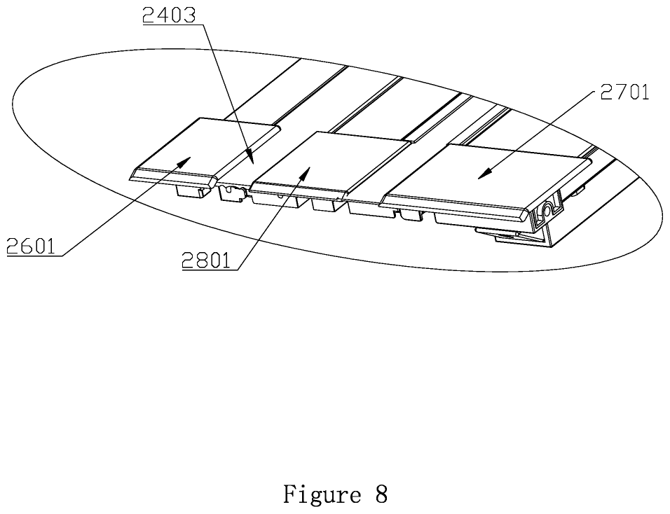

On the basis of embodiment 2, as shown in FIGS. 5-8, the first rotating shaft system 2 includes a first intermediate rotating bar 21 and two first side bars 23, the two first side bars 23 are respectively connected to the first intermediate rotating bar 21 by rotation (each of the two first side bars 23 rotates 95°-110° around the first intermediate bar), the first side bars 23 are provided with a side bar mounting groove 2302, the side bar mounting grooves 2302 are “C” shaped, the first intermediate bar 21 is provided with an intermediate mounting groove 2101 at each end, the intermediate mounting groove 2101 are “C” shaped, (“C” structure not only makes the first connecting strip 24 stable, but also allows the size of the groove to be adjusted so as to control the tightness of the connecting strip with the side or intermediate bars), the two first side bars 23 and the first intermediate bar 21 is connected with a first connecting strip 24, the first connecting strip 24 is made of rubber, the first connecting strip 24 includes a first connecting surface 2403 and two first feet 2401, the two first feet 2401 are connected by the first connecting surface 2403, the two first feet 2401 are located in the side bar mounting groove 2302 and the intermediate mounting groove 2101 respectively, the first side bar 23 is provided with a side bar convex block 2301, the side bar convex block 2301 is connected to the notch of the side bar mounting groove 2302, the first intermediate rotating bar 21 is provided with an intermediate convex block 2102, the intermediate convex block 2102 is connected to the notch of the intermediate mounting groove 2101, the intermediate convex block 2102 is longer than the side bar convex block 2301, or alternatively the intermediate convex block 2102 is shorter than the side bar convex block 2301, as long as it is ensured that the notched of the side bar mounting groove 2302 and the intermediate mounting groove 2101 are not the same size.

By providing side bar convex block 2301 in side bar mounting groove 2302 and intermediate convex block 2102 in intermediate mounting groove 2101 and controlling the length of side bar convex block 2301 and intermediate convex block 2102, the size of the groove can be reduced so that after the first foot 2401 can be removed after it is extended into side bar mounting groove 2302 and intermediate mounting groove 2101 due to the short side bar convex block 2301, the first foot 2401 in the intermediate mounting groove 2101 cannot be removed if the intermediate convex block 2102 is longer.

Since the first bottom foot 2401 can be removed from the side bar mounting groove 2302, the first connecting strip 24 plays only a waterproof role but not the connecting role. The connection of the first rotating shaft system 2 is however still connected by rotation through the first intermediate rotating bar 21 and the front bar rotating centre of the first side bar 23. The first rotating shaft system 2 adopted a rubber strip, which reasonably reduces production cost.

The first rotating shaft system 2 has a left end cap 26, a right end cap 27 and an intermediate end cap 28, the left end cap 26 and the right end cap 27 are screwed to the two first side bars 23 respectively, the intermediate end cap 28 is screwed to the first intermediate rotating bar 21, the left end cap 26 is provided with a left end cap top panel 2601, the right end cap 27 is provided with a right end cap top panel 2701, the intermediate end cap 28 is provided with an intermediate end cap top panel 2801, the left end cap top panel 2601, the right end cap top panel 2701 and the intermediate end cap top panel 2801 are provided on the upper side of the first connecting surface 2403.

The first connecting strip 24 is of “π” shape, the first foot 2401 is connected to the first connecting surface 2403 by means of a connector (not shown in the drawing), the size of the first foot 2401 is larger than the size of the connector and the connector is slightly smaller than the notch of the intermediate mounting groove 2101.

The first connecting strip 24 is designed as a “π”-shaped structure, which provides good stability and water proofing after connection, the first connecting strip 24 is set on the upper side of the front bar rotation centre of the first rotating shaft system 2, so when the first rotating shaft system 2 is rotating, the first connecting strip 24 will not be subject to tension, which prevents damage to the first connecting strip 24 caused by long-term rotation.

### Embodiment 4

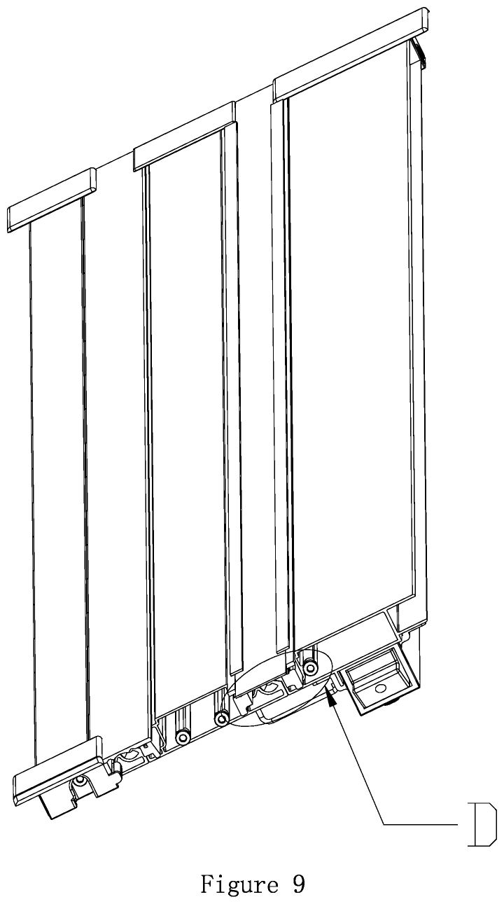

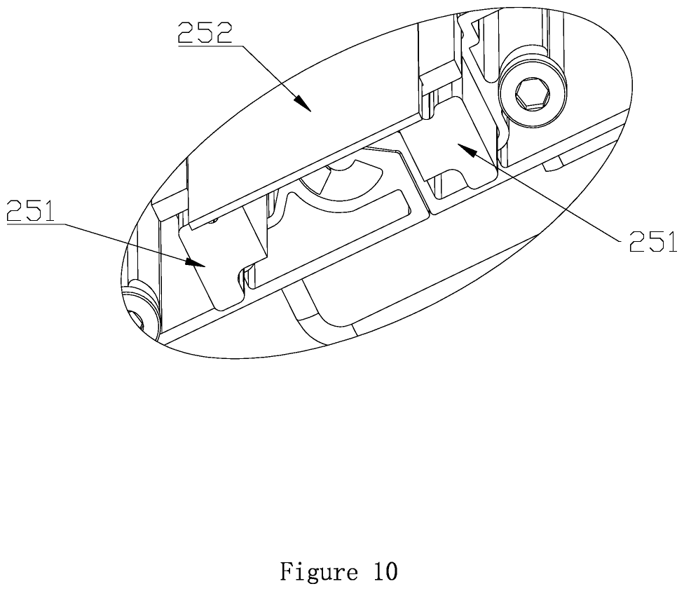

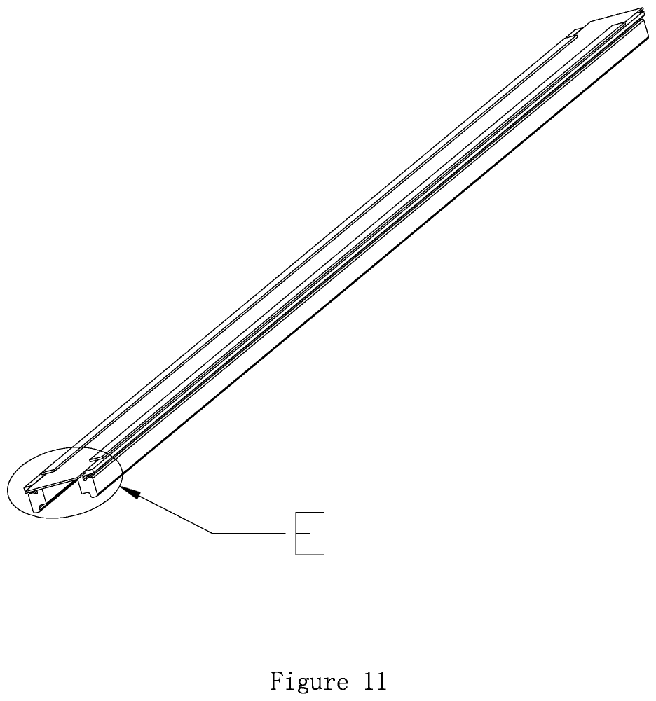

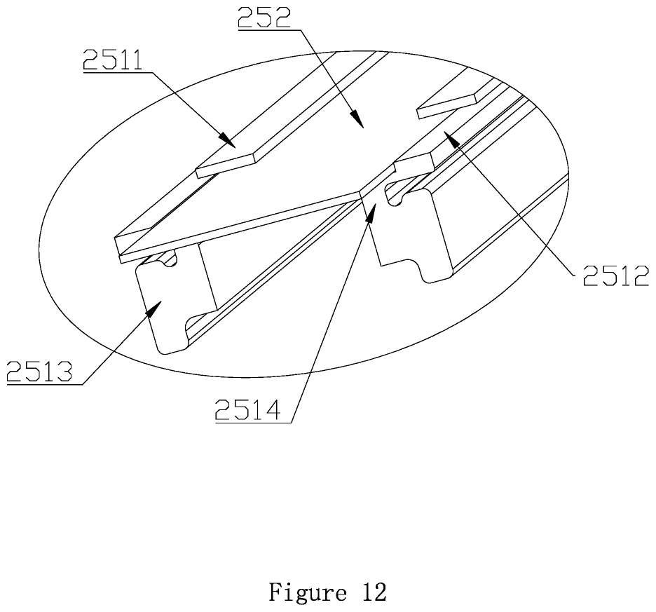

On the basis of embodiment 1, as shown in FIGS. 9-12, the rotating shaft system includes a second rotating shaft system 3, the second rotating shaft system 3 includes a second intermediate rotating bar and two second side bars 31, the two second side bars 31 is respectively connected to the second intermediate rotating bar by rotation, the second side bars 31 are provided with a side bar mounting groove 2302, the second intermediate rotating bar is provided with two intermediate mounting grooves 2101, the second side bars 31 are connected to the second intermediate rotating bar with a second connecting strip 25, the second connecting strip 25 includes a second connecting surface 252 and two mounting sections 251, the second connecting surface 252 can be leather or other non-elastic flexible material (the second connecting strip 25 is a split structure, the two mounting sections 251 are made of plastic, the second connecting surface 252 in the centre is not elastic, however it can be bent and deformed, the second connecting surface 252 is glued or sewn to the two mounting sections 251 to ensure its tightness when connecting), the two the mounting sections 251 are connected by the second connecting surface 252, each mounting section 251 is connected with a second foot 2513, the two second feet 2513 are located in the side bar mounting groove 2302 and the intermediate mounting groove 2101 respectively.

The second rotating shaft system 3 designed the second connecting strip 25 as a split structure, the second connecting surface 252 and the mounting section 251 are connected by glue during installation, the second foot 2513 is similarly inserted into the profile when using. The second connecting surface has a longer service life due to its plastic material.

Since the second rotating shaft system 3 has to be opened each time it is opened, adopting a plastic material for the second rotating shaft system 3 not only extends the service life of the second rotating shaft system but also reduces the cost.

### Embodiment 5

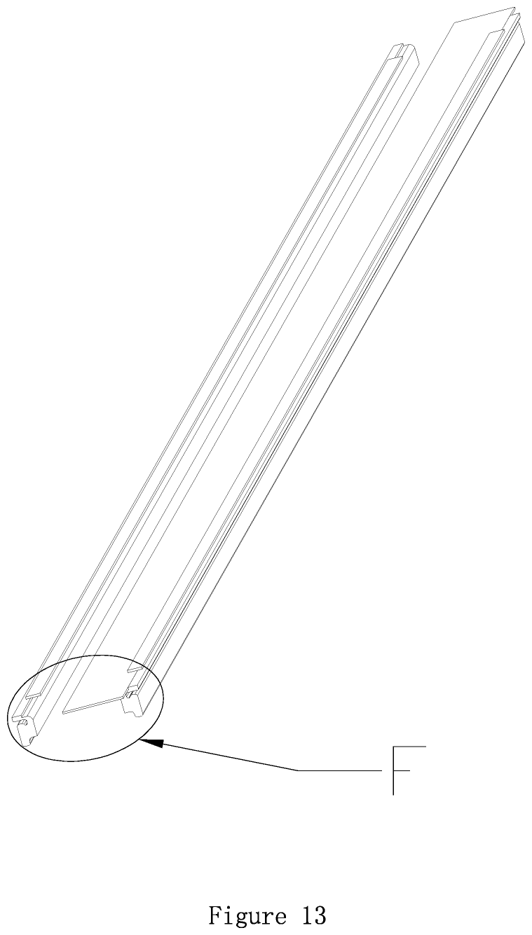

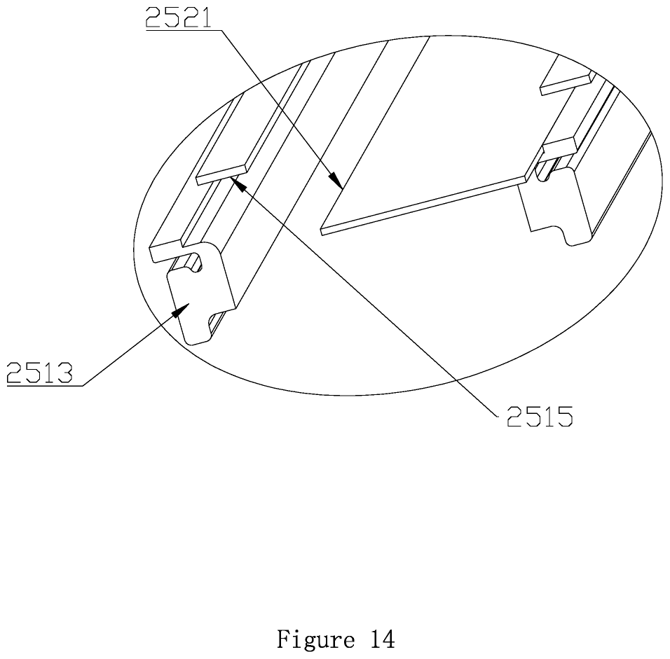

On the basis of embodiment 4, as shown in FIGS. 13-14, the mounting section 251 includes a pressing plate 2511, a connecting section 2512 and a supporting section 2514, the supporting section 2514 is provided with a connecting section 2512 on its upper side, the connecting section 2512 is provided with a pressing plate 2511 on its upper side, an insertion port is provided with between the pressing plate and the supporting section, the second connecting surface 252 is provided with insertion ends 2521 at both ends, the insertion ends 2521 extending into the insertion port 2515.

The two insertion ports 2515 are provided opposite each other.

When actually installed, the insertion end 2521 is coated with glue and then inserted into the insertion port 2515, and once the glue has set, the second connecting surface 252 is tightly connected to the mounting part 251.

### Embodiment 6

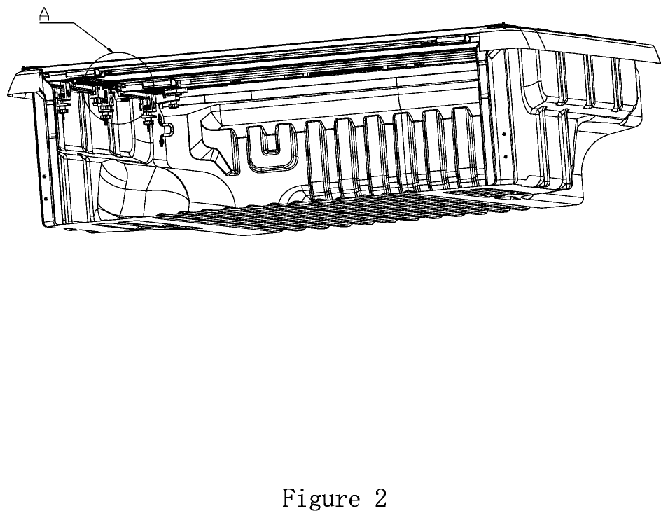

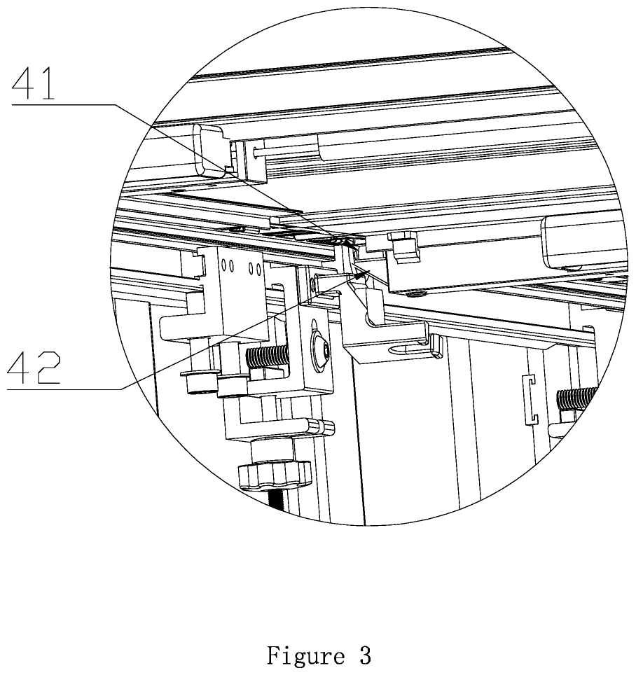

On the basis of Embodiment 5, as shown in FIGS. 2-3, the car cover further includes a guide rail, a clamp system and a lock system, the guide rail is connected to the cargo hopper through the clamp system, the lock system includes a cylindrical lock bolt head 41 and a lock bolt 42, the lock bolt 42 is connected to the car cover, the cylindrical lock bolt head 41 is connected to the cargo hopper or the guide rail by a clamp system.

Each cover plate is provided with a lock system correspondingly, the lock system includes two lock bolts 42 and two cylindrical lock bolt heads 41, the two cylinders are connected on each side of the cargo hopper, the two lock bolts are connected on each side of the plate and correspond to the lock bolt cylinders at the same time, the two the lock bolts 42 are connected to each other by means of a wire rope, the wire rope is connected to a handle.

By pulling the handle, the locking system can be opened quickly to facilitate the opening of the car cover, in addition, when closing the car cover, it just need to press down on the plate body.

The invention is not limited to the above-mentioned optional embodiments, anyone can come up with various other forms of products under the inspiration of the invention, however, regardless of any changes in its shape or structure, all technical solutions that fall within the scope defined by the claims of the present invention shall fall within the scope of protection of the invention.

1. A hard flipping car cover, wherein, it includes a front bar system, a first plate body (5), a second plate body (6), a third plate body (7) and a supporting system,
the supporting system includes a buffer plate (85), a buffer block (84) and a large front bar rotating shaft (1), the buffer plate (85) is connected to the front car cab (9) and the buffer block (84) is connected to the front bar system,
the first plate body (5) is rotatably connected to the front bar system by a large front bar rotating shaft (1), the first plate body (5) is rotatably connected to a second plate body (6) by a first rotating shaft system (2),
the second plate body (6) is rotatably connected to the third plate body (7) by a second rotating shaft system (3).

2. A hard flipping car cover according to claim 1, wherein, the supporting system further includes a supporting pole assembly, the supporting pole assembly includes a supporting pole (81), a supporting pole head (82) and a supporting block (83), the supporting pole head (82) is connected to the plate body through a supporting base (86), the supporting base (86) is set parallel to the plate body, the supporting block (83) includes a fixing section (831), an inclined plate (832), a supporting groove (833) and a transition section (834), the fixing section (831) is connected to the cargo hopper, the inclined plate (832) is connected to the fixing section (831) through the transition section (834), the inclined plate (832) is inclined 15-25° with respect to the fixing section (831), the inclined plate (832) is provided with a “U” shaped supporting groove (833), the supporting pole (81) is snap fitted into the supporting groove (833).

3. A hard flipping car cover according to claim 1, wherein, the large front bar rotating shaft (1) includes a top pillar (11) and a front bar rotating centre (12), the front bar rotating centre (12) is connected to the top pillar (11) by rotation, the front bar rotating centre (12) is connected to the first plate body (5) by a connecting arm (13), the front bar rotating centre (12) is provided with a first limiting section (14), the top pillar (11) is rounded and the top pillar (11) is provided with a second limiting section (15) which is adapted to the first limiting section (14).

4. A hard flipping car cover according to claim 1, wherein, the first rotating shaft system (2) includes a first intermediate rotating bar (21) and two first side bars (23),
The two first side bars (23) are respectively connected to the first intermediate rotating bar (21) by rotation, the first side bar (23) is provided with side bar mounting grooves (2302), the side bar mounting groove (2302) is of “C” shaped, the first intermediate rotating bar (21) is provided with an intermediate mounting groove (2101) at each end, the intermediate mounting groove (2101) is “C” shaped. the intermediate mounting groove (2101) is “C” shaped, the two first side bars (23) are connected to the first intermediate bar (21) by a first connecting strip (24), the first connecting strip (24) is made of rubber,
the first connecting strip (24) includes a first connecting surface (2403) and two first feet (2401), two said first feet (2401) are connected by the first connecting surface (2403), the two first feet (2401) are located in the side bar mounting groove (2302) and the intermediate mounting groove (2101) respectively, the side bar convex block (2301) is connected to the north of the side bar mounting groove (2302), the first intermediate rotating bar (21) is provided with an intermediate convex block (2102), the intermediate convex block (2102) is connected to the north of the intermediate mounting groove (2101), the intermediate convex block (2102) is longer than the side bar convex block (2301).

5. A hard flipping car cover according to claim 4, wherein, the first rotating shaft system (2) is connected with a left end cap (26), a right end cap (27) and an intermediate end cap (28) at each end, the left end cap (26) and right end cap (27) are screwed to the two first side bars (23) respectively, the intermediate end cap (28) is screwed to the first intermediate rotating bar (21), the left end cap (26) is provided with a left end cap top panel (2601), the right end cap (27) is provided with a right end cap top panel (2701), the intermediate end cap (28) is provided with an intermediate end cap top panel (2801), the left end cap top panel (2601), right end cap top panel (2701) and middle end cap top panel (2801) are all provided on the upper side of the first connecting surface (2403).

6. A hard flipping car cover according to claim 4, wherein, the first connecting strip (24) is of “π” shape, the first base foot (2401) is connected to the first connecting surface (2403) by a connection member, the size of the first base foot (2401) is larger than the size of the connection member.

7. A hard flipping car cover according to claim 1, wherein, the second rotating shaft system (3) includes a second intermediate rotating bar and two second side bars (31), the two second side bars (31) is connected to the second intermediate rotating bar by rotation, the second side bars (31) are provided with a side bar mounting groove (2302), the second intermediate rotating bar is provided with two intermediate mounting grooves (2101), the second side bar (31) is connected to the second intermediate rotating bar by a second connecting strip (25).
the second connecting strip (25) includes a second connecting surface (252) and two mounting sections (251), the second connecting surface (252) is of a flexible material, the two mounting sections (251) are connected by the second connecting surface (252), each mounting section (251) is connected with a second base foot (2513), the two second base feet (2513) are located in the side bar mounting groove (2302) and in the intermediate mounting groove (2101) respectively.

8. A hard flipping car cover according to claim 7, wherein, the mounting section (251) includes a pressing plate (2511), a connecting section (2512) and a supporting section (2514), the supporting section (2514) is provided with a connecting section (2512) on its upper side, the connecting section (2512) is provided with a pressing plate (2511) on its upper side, the pressing plate (2511) is provided with an insertion port (2515), which located between the pressing plate (2511) and the supporting section (2514), the second connecting surface (252) is provided with a insertion end (2521) at both ends, the insertion ends (2521) extend into the insertion port (2515).

9. A hard flipping car cover according to claim 1, wherein, the buffer block (84) includes a buffer pad (841) and a fixing pad (842), the fixing pad (842) is connected to the front bar system, the buffer pad (841) is connected to the fixing pad (842), the buffer pad (841) is of “L” type structure.

10. A hard flipping car cover according to claim 1, wherein, the car cover further includes a guide rail, a clamp system and a lock system, the guide rail is connected to the cargo hopper through the clamp system, the lock system includes a cylindrical lock bolt head (41) and a lock bolt (42), the lock bolt (42) is connected to the car cover, the cylindrical lock bolt head (41) is connected to the cargo hopper or to the guide rail through the clamp system.
